(19) United States
(12) Patent Application Publication
(10) Pub. No.: US 2009/0123993 A1
(43) Pub. Date: May 14, 2009

(54) BIOREACTOR FOR DEVELOPMENT OF BLOOD VESSELS

(75) Inventors: Albert J. Banes, Hillsborough, NC (US); Jian Wang, Durham, NC (US); Jie Qi, Chapel Hill, NC (US); Kamyar Kheradpir, Durham, NC (US)

Correspondence Address: THE WEBB LAW FIRM, P.C., 700 KOPPERS BUILDING, 436 SEVENTH AVENUE, PITTSBURGH, PA, 15219, US

(73) Assignee: MEDTRAIN TECHNOLOGIES, LLC, Hillsborough, NC (US)

(21) Appl. No.: 11/909,858

(22) PCT Filed: Mar. 30, 2006
(86) PCT No.: PCT/US06/12086

§ 371 Date: Jun. 18, 2008

Related U.S. Application Data
(60) Provisional application No. 60/667,489, filed on Mar. 31, 2005.

(51) Int. Cl. A01N 1/02

(52) U.S. Cl. 435/284.1

(57) ABSTRACT

The present invention provides a blood vessel bioreactor and accessory system to harvest, maintain, transport, and/or develop a native blood vessel or a tissue-engineered biosynthetic blood vessel construct in which regulated nutritive fluid flow as well as a pressure and shear stress regimen is supplied which nutritionally and mechanically conditions the native or tissue-engineered blood vessel construct to withstand an in vitro or in vivo environment. The present invention includes a blood vessel harvest and carriage cassette (10) which allows for the isolation of a blood vessel segment in situ, engagement of a defined length and bore size of the blood vessel segment with a blood vessel attachment/engagement cuff (20), severing of the blood vessel segment, attachment of the severed ends of the blood vessel segment with various types of blood vessel inlet/outlet cuff connectors that connect to a nutritive fluid flow system, and a cassette-type bioreactor cartridge.

### BACKGROUND OF THE INVENTION

1. Field of the Invention

The present invention relates to bioreactor systems for vascular graft culture and tissue engineering. More particularly, the present invention relates to a computer-controlled bioreactor system useful for harvesting, transporting, long-term maintenance and development of blood vessels for cardiovascular disease investigation, drug testing and tissue engineering.

2. Description of Related Art

Cardiovascular disease (CVD) is a leading cause of death in the United States. Over 2,600 people or one person every 30 seconds dies from heart disease each day. The cost (direct and indirect) of cardiovascular diseases and stroke in 2004 was estimated to be $368.4 billion in the United States, according to the American Heart Association and the National Heart, Lung, and Blood Institute. The World Health Organization estimates that 16.9 million people around the globe die of cardiovascular diseases each year.

Individuals who are genetically predisposed to CVD, such as diabetics, and those individuals who develop atherosclerosis, require vessel clearance, repair, or replacement. Vessel clearance is accomplished by routing the obstructed channel until a degree of patency is obtained. Vessel repair can be manifested by fragmenting atherosclerotic plaque or other obstructions by vessel expansion using a balloon catheter, then inserting a stent to maintain vessel patency.

Large vessels can readily be treated or repaired. For example, large vessels that have undergone pathologic change, such as a dissecting aneurysm or burst wall, and thus which require partial replacement, may be replaced with DACRON™ or GoreTex™ tubular devices which are sutured to either end of the damaged vessel. In addition, rather than surgically remove a segment of a damaged blood vessel, the damaged section of the vessel can be treated with an internal sleeve. In this way, the walls of the original vessel are left intact and the damaged internal wall is repaired with an internal stent that prevents further tearing and dehiscence of the intima, or endothelial lining of the vessel. In contrast, treatment and repair of smaller vessels have proven more problematic. For example, challenges remain for the repair or replacement of mid-size arteries that service the heart muscle, such as the carotid arteries. These vessels have approximately a 3-5 mm internal diameter bore size and represent a major portion of the surgical cases that usually can be repaired only by vessel expansion and stent placement. A major problem is that 50-60% of these vessels occlude again after repair and stent placement within six to twelve months, even when an anti-clotting medication, such as coumadin, is administered. Additionally, smaller vessels cannot be replaced with synthetic materials, such as DACRON™ or GoreTex™, because these materials cause clotting in smaller bore tubes in vivo.

Large vessel synthetic graft devices have been available for many years. However, engineering small diameter vascular devices or tissue engineered constructs has proven more difficult because of the increased incidence of thrombosis and occlusion which typically occur with these devices and constructs. Artificial vessel endothelialization is one of the methods used to solve the challenge of thrombosis (blood clotting). However, human endothelial cells adhere weakly to currently available vascular graft materials. Some expanded polytetrafluoroethylene grafts have shown only about a 10%+/−7% overall attachment of endothelial cells. Moreover, when a graft is exposed to pulsatile blood flow, a higher proportion of cells may elute from the luminal wall, with maximum cell detachment occurring in the first 30-45 minutes after exposure to pulsatile flow and with up to 70% of the initial cell population removed during that time; a lower rate of detachment occurring over the next 24 hours. The lack of cell retention may be overcome partly by additional cell seeding. Other techniques, such as engineering the vessel lumen with adhesion factors, have been developed to improve endothelial cell adhesion and retention rate. These techniques include shear stress preconditioning, electrostatic charging and precoating the lumen with endothelial cell-specific adhesion glues that are characteristic of the extracellular basement membrane of blood vessels. The most common techniques are chemical coatings, preclotting, chemical bonding and surface modifications (Xiao, Chin., J. Traumatol., 7(5):312-6, 2004). Additionally, substantial efforts are being invested by the bioengineering community to develop biodegradable polymer scaffolds suitable for tissue engineering applications. Many new materials have been developed such as a poly (L-lactide-co-epsilon-caprolactone) copolymer, which has a novel architecture produced by an electrospinning process.

Biodegradable materials formed in tubular shapes seeded with autologous cells have attracted much interest as potential cardiovascular grafts. However, pretreatment of these materials with cells requires a complicated and invasive procedure to collect vessel tissue, culture the cells and seed the graft before implantation in a patient. This procedure requires two surgical procedures and carries a risk of infection. A biodegradable graft material which contains a collagen microsponge that encourages the regeneration of autologous vessel tissue has been developed which appears to overcome these problems. The poly (lactic-co-glycolic acid)-collagen microsponge patch with and without precellularization has shown to have good histologic properties and durability (Iwai S., J. Thorac. Cardiovasc. Surg., 128(3):472-9, 2004).

However, the success of tissue engineering and biomaterial applications in blood vessel fabrication not only is dependent on the initial functioning of the device with regard to patency, anastomosis and bursting strength, but also is dependent on the successful vascularization of the implant itself after implantation. The process of vascularization involves angiogenesis, i.e., the formation of new blood vessels which spread into the implant material and supply the existing cells with the nutrients to survive. In vitro methods have been established using human microvascular endothelial cells to populate novel biomaterials to test endothelial cell attachment, cytotoxicity, growth, angiogenesis and the effects on gene regulation. Results from in vitro studies may be used to evaluate the potential success of a new biomaterial and for the development of matrix scaffolds which will promote a physiological vascularization response (Kirkpatrick, C. J., J. Mater. Sci. Mater. Med., 14(8):677-81, 2003).

Currently, biomaterials are widely used in medical sciences. The field of biomaterials began to shift to produce materials able to stimulate specific cellular responses at the molecular level. The combined efforts of cell biologists, engineers, materials scientists, mathematicians, geneticists, and clinicians now are used in tissue engineering to restore, maintain, or improve tissue functions or organs. This rapidly expanding approach combines the fields of material sciences and cell biology for the molecular design of polymeric scaffolds with appropriate three-dimensional configuration and biological responses.

Tissue engineering of biomaterials may offer patients new options when replacement or repair of an organ is needed. However, most tissues require a microvascular network to supply oxygen and nutrients. One strategy for creating a microvascular network is to promote vasculogenesis in situ by seeding vascular progenitor cells within the biopolymeric construct. To pursue this strategy, CD34(+)/CD133(+) endothelial progenitor cells (EPCs) have been isolated from human umbilical cord blood and expanded ex vivo as EPC-derived endothelial cells. EPCs appear to be well suited for creating microvascular networks within tissue-engineered constructs (Bischoff, J., Am. J. Physiol. Heart Circ. Physiol., August; 287, 2004). Additionally, basic fibroblast growth factor (bFGF) coating has been tested to promote endothelial cell seeding and proliferation on a decellularized heparin-coated vascular graft. This coating has been shown to increase the retention of seeded cells on the graft under flow conditions. In one study, after only three hours of cell attachment, 60% of human microvascular endothelial cells (HMECs), as well as canine peripheral blood endothelial progenitor cells (CEPCs), were shown to be retained in intact grafts exposed to flow relative to the static control graft group, thus demonstrating that bFGF coating on the heparin bound decellularized grafts significantly increased both HMEC and CEPC proliferation and that seeded cells remained stable under perfusion conditions (Conklin, B. S., Artif. Organs., 28(7):668-75, 2004).

Autologous transplantation of “artificial blood vessels” as arterial interposition grafts has been performed successfully in a canine model, in which peritoneal and pleural cavities of large animals have been shown to function as bioreactors to grow myofibroblast tubes for use as autologous vascular grafts (Chue, W. L., J. Vasc. Surg., 39[4]:859-67, 2004). Progress in tissue engineering now allows the recreation of functional blood vessels from cultured human vascular cells. When reconstructed under specific conditions, their structure, mechanical properties and function (especially vasomotricity) allow them to be used as human models for studying the biology and pharmacology of blood vessels.

To date, biomedical investigators have developed methods to remove pathologic blood vessels from patients in procedures that involve coronary or carotid artery opening, vena cava removing or sleeving and vein stripping. Surgical techniques are well developed that result in a vessel that can be anastomosed by suturing the implant ends to existing ends of blood vessels. Initially, investigators have focused on the use of autologous blood vessel parts to repair or replace vessels damaged by trauma or disease. Materials scientists have joined with clinicians to develop synthetic devices, such as the DACRON™ vena cava replacement. Implantation of this device requires the removal of the enlarged, pathologic vessel segments and the sutured connection of the radiator hose-like device to the living vessel ends. Similar devices comprised of GoreTex™ have been implanted in a similar fashion. There are principle concerns with the use of these devices, however, which include the strength of the anastomoses, as the connection of the device is affected by suturing to the living vessel ends; and leakage of blood through the permeable textile wall and subsequent blood clotting on the outside wall as well as the inside wall. An initial design feature had included blood clotting itself, which sealed the device from further leakage of blood into the body cavity. However, patients had to be treated with anticlotting agents, such as coumadin, to prevent excessive clotting and a possible life-threatening embolism that could occlude a vessel downstream from the device.

Research and development have continued on the design of novel biomaterials and architectures for vessel replacement devices that are synthetic, biosynthetic or biological. For biological devices, a bioreactor typically is required to sustain cell viability and stimulate development of cells to maintain and build a vessel architecture which functions without clotting, bursting or leakage at the anastomoses or through the vessel wall. This level of design, fabrication and use that results in the development of a substitute vessel that acts sufficiently well to replace an existing blood vessel or other conduit in the body is referred to as Functional Tissue Engineering of a substitute vessel. Bioreactor designs suitable for the maintenance or development of blood vessels involve at least two major aspects: (1) the development of a tubular scaffold that can be used as a framework for vessel-specific cell attachment and function; and (2) the design of a bioreactor that provides a suitable environment in which to maintain and/or develop a blood vessel phenotype for the cells which may be seeded into the scaffold lumen, interior wall and exterior wall. The engineered blood vessel substitute may also have specially designed ends which provide functional attachment points from the engineered vessel to the ends of the living vessels for anastomosis.

Examples of tubular scaffold designs include, but are not limited to, extruded materials, sheets of materials that are rolled into a tube and contain a seam, sheets of materials that are rolled into a tube and are seamless, sheets of materials that form an undulating pattern and are mated with a mirror image-shaped material to form tubes, undulating sheets of material that have a flat sheet of a secondary material bonded to the surface to form tubes, materials that are formed on a mandril into a tube, materials that are spun into a tube, materials that are woven into a tube, rings of material that are stacked to form a tube, solid materials that have material removed so that a cavity or cavities remains which are laser or otherwise “burned” to create a tube or tubes, particles that are progressively laid down in a pattern to form a tube, materials that are expanded to form a tube, and materials that condense to form a tube. Currently, no dominant type of tube formation has prevailed. However, typically a blood vessel open pore scaffold is obtained by providing a tubular shape formed by extrusion or seamless sheet folding into a tube in which the tube is populated with endothelial cells on the inner (luminal) surface and with smooth muscle cells in the interstices of the tube wall. Adventitial cells then can be seeded on the exterior surface of the scaffold. In this way, the gross anatomy of the blood vessel with respect to major histologically defined layers is simulated.

Bioreactors have also been developed to maintain blood vessels removed from the body or to stimulate the development of bioengineered vessels. Most of the bioreactor designs involve a single or multiple of cylindrical chambers with capped and plugged inlet and outlet ends that service fluid flow through the blood vessel lumen. A second inlet and outlet service the chamber surrounding the exterior wall of the blood vessel. Hence, the design typically includes a tube within a tube chamber in which the inner tube is the blood vessel with its flow independent of the flow of the exterior chamber which provides the nutrient flow to the blood vessel exterior. Each flow path is controlled by a syringe pump or peristaltic pump with pressure controllers, pulse dampeners and regulation of flow rate. Certain blood vessel bioreactors also provide uniaxial strain to simulate strain experienced by a vessel upon elongation of the draining limb, or torque to simulate the twisting motion of, for example, limb muscles. However, no evidence has been reported that these added mechanical features actually benefit the blood vessel or bioengineered construct to increase their mechanical strength or to maintain a blood vessel phenotype. Indeed, there usually is some difficulty in clamping or suturing a blood vessel segment onto an inlet or outlet fixture and loading the blood vessel into a cylindrical tube. Furthermore, there also is the problem of maintaining sterility for long periods in conventional bioreactors, particularly if sampling from the medium is routinely performed.

There exists a need, therefore, for a blood vessel bioreactor system which can harvest, transport, maintain and develop native or biosynthetic blood vessels from small bore to large bore sizes under aseptic conditions.

### SUMMARY OF THE INVENTION

The present invention provides a blood vessel bioreactor and accessory system which can be used to maintain a native blood vessel or to develop a tissue-engineered biosynthetic blood vessel construct in which regulated nutritive fluid flow as well as a pressure and shear stress regimen is supplied which nutritionally and mechanically conditions the native or tissue-engineered blood vessel construct to functionally withstand an in vitro or in vivo environment. Additionally, engineered parts of the bioreactor system are designed to encourage ingrowth of the vessel ends into functional integrative connections which can readily be joined to a living blood vessel tissue in the body.

In particular, the blood vessel bioreactor and accessory system of the present invention is a complete system which allows for the stepwise isolation of a blood vessel segment in situ, engagement of a defined length and bore size of the blood vessel segment with a blood vessel attachment/engagement cuff, severing of the blood vessel segment, attachment of the severed ends of the blood vessel segment with various types of blood vessel inlet and outlet cuff connectors that provide a positive connection to a nutritive fluid flow system, and a cassette-type bioreactor cartridge for the harvesting, transport, maintenance and/or development of native or tissue-engineered blood vessels. The novel features of the blood vessel bioreactor system allow for ease of collection of a living blood vessel in an animal or human for the purpose of removal of the blood vessel and connection to other blood vessels in the body and/or connection to a bioreactor flow system for the purpose of conditioning the blood vessel(s) by biochemical and/or electrical and/or mechanical means.

The blood vessel bioreactor system therefore is capable of engaging a blood vessel segment on its exterior surface by vacuum in a defined way and geometry for the purpose of gauging its length, engaging it in a manner that does not excessively compress or damage the blood vessel ends and allows for the defined severing of the blood vessel so that it can be removed from the body of an animal or human. The blood vessel bioreactor system includes a blood vessel transport cassette for the transport of the blood vessel segment from one site, such as an operatory or surgical suite, to another site for the purpose of reimplantation, maintenance and/or culture of the blood vessel. The connections in the bioreactor which supply the blood vessel with nutrient fluid flow are designed to allow ease of connection and disconnection from the bioreactor unit and subsequent implantation in a patient or other subject.

### BRIEF DESCRIPTION OF THE DRAWINGS

FIG. 1 is a three-dimensional rendering of a typical blood vessel bioreactor set-up;

FIG. 2 shows a blood vessel harvest and carriage cassette;

FIG. 3 shows a blood vessel transport cassette;

FIG. 4 shows a blood vessel attachment/engagement cuff;

FIG. 5 is a top view of a blood vessel bioreactor;

FIG. 6 is a perspective view of a blood vessel bioreactor;

FIG. 7 shows a bayonet-type blood vessel inlet/outlet cuff connector;

FIG. 8 shows a mechanical clamp blood vessel inlet/outlet cuff connector having at least four flexible hinge arms with an “O” ring engagement clamp;

FIG. 9 shows particular details of the mechanical clamp blood vessel inlet/outlet cuff connector;

FIGS. 10A-D show the mechanical clamp blood vessel inlet/outlet cuff connector in various stages of connection to a blood vessel segment. FIG. 10A shows the connector about to receive a blood vessel segment. FIG. 10B shows the blood vessel segment received onto a bayonet-type fitting at the distal end of the tube of the connector. FIG. 10C shows the four arms of the clamp/engagement mechanism having moved more circumferentially to apply pressure by virtue of the flexible “O” ring received into a depression in each section of each arm. FIG. 10D shows a clamped blood vessel segment end captured by the connector mechanism;

FIG. 11 shows the mechanical clamp blood vessel inlet/outlet cuff connector connected to adjustable length rigid tubing at the proximal end and a seal and flow connector at the distal end;

FIG. 12 shows a wet tack sleeve blood vessel inlet/outlet cuff connector;

FIG. 13 shows a vacuum-operated blood vessel inlet/outlet cuff connector; and

FIGS. 14A-C show a two-piece blood vessel inlet/outlet cuff connector having a perforated magnetic sleeve for use as a vacuum-operated and magnetic vessel attachment connector. FIG. 14A shows the two parts of the perforated magnetic sleeve. FIG. 14B shows the perforated magnetic sleeve with a blood vessel therein. FIG. 14C shows the engagement of the two parts of the perforated magnetic sleeve.

### DETAILED DESCRIPTION OF THE INVENTION

The present invention provides a novel blood vessel bioreactor system for the harvest, maintenance, transport and/or development of native blood vessels or other tubular biological structures, such as tissue-engineered biosynthetic blood vessel constructs. The bioreactor system is comprised of a blood vessel harvest and carriage cassette and a computer-operated blood vessel bioreactor flow system for the harvest, maintenance, transport and/or development of native blood vessels or other tubular biological structures, such as tissue-engineered biosynthetic blood vessel constructs.

A complete understanding of the present invention will be obtained from the following description taken in connection with the accompanying drawing figures, wherein like reference characters identify like parts throughout.

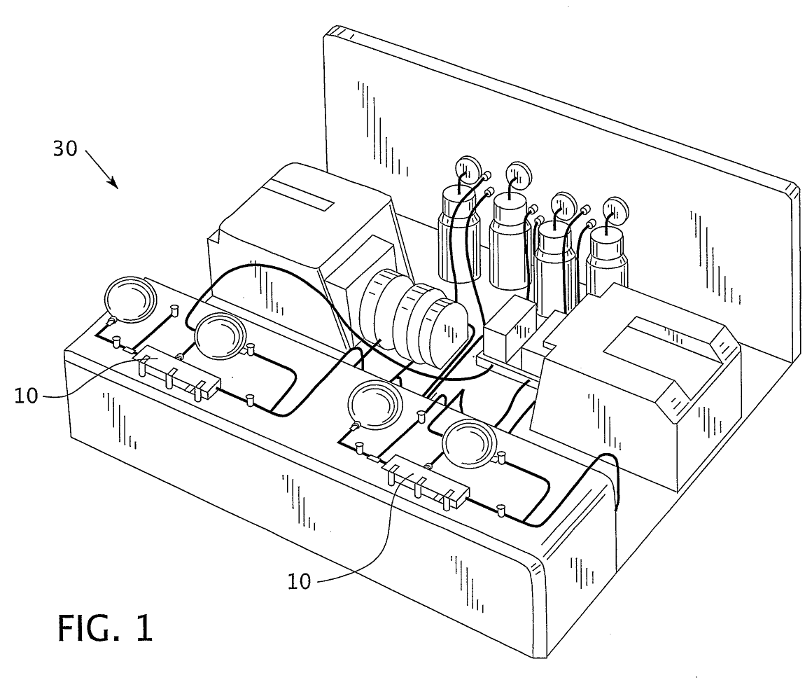

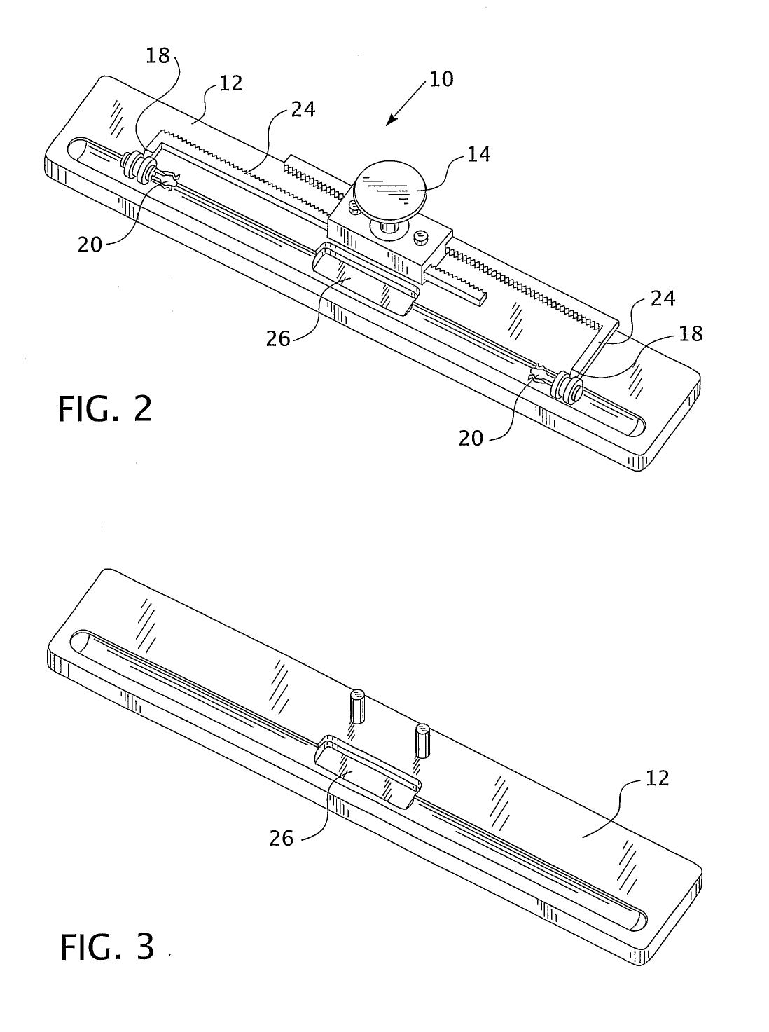

FIG. 1 shows a typical ByPass™ blood vessel bioreactor 30 into which one or more blood vessel harvest and carriage cassettes 10 are inserted. As shown in FIGS. 2-3, the blood vessel harvest and carriage cassette 10 is comprised of a transport cassette 12 having a linear, tubular handle 14 positioned centrally thereon. The transport cassette 12 has a depression therein 26 for filling with a nutritive fluid. The linear, tubular handle 14 is in line with vacuum tubing 24 extending out from either side of the handle 14. The interior of the handle 14 communicates with a vacuum connection within the vacuum tubing 24 and the vacuum tubing 24 terminates in a blood vessel end engagement part 18 having a perforated, circular or semi-circular blood vessel attachment/engagement cuff thereon 20. The handle 14 is rotatable so as to vary the length of the vacuum tubing 24 on the blood vessel transport cassette 12.

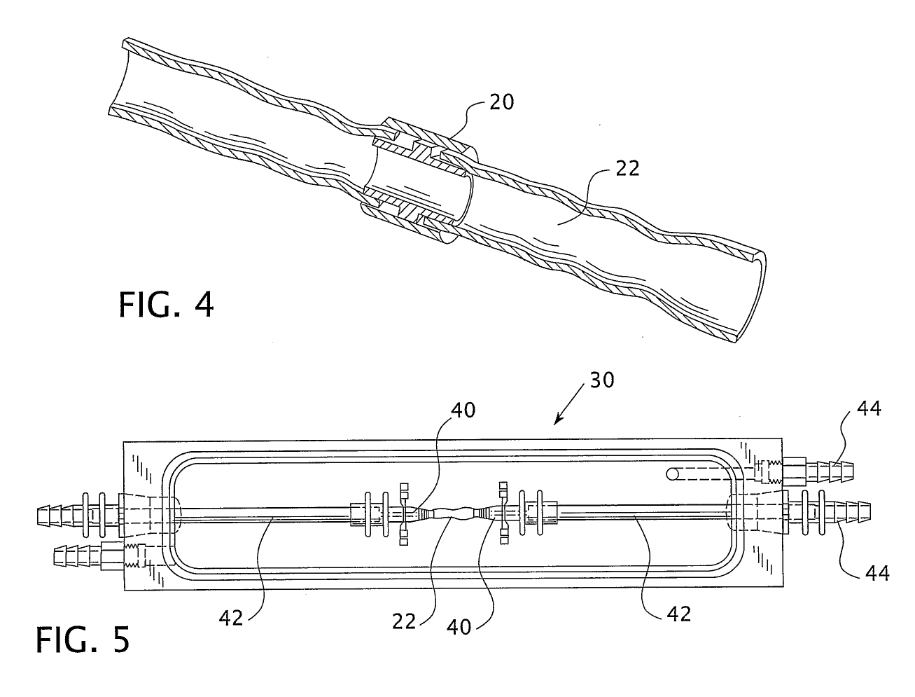

FIG. 4 shows the blood vessel attachment/engagement cuff 20, which is configured to attach, via vacuum aspiration, to the exterior wall of a blood vessel 22 of an animal or human, in which the attachment point is proximal to the segment end of the blood vessel 22. In this way, the blood vessel segment 22 is immobilized and maintained in a patent state. The attached blood vessel segment 22 then can be detached from the remainder of the blood vessel that remains intact in the body of the animal or human and transported in the transport cassette 12 (FIG. 3) to a laboratory or surgical setting, after which the transported detached blood vessel segment 22 can be removed from the transport cassette 12 using the handle 14 to lift the blood vessel segment 22, blood vessel attachment/engagement cuff 20 and vacuum tubing 24 off of the transport cassette 12 for subsequent connection to a flow chamber in a bioreactor.

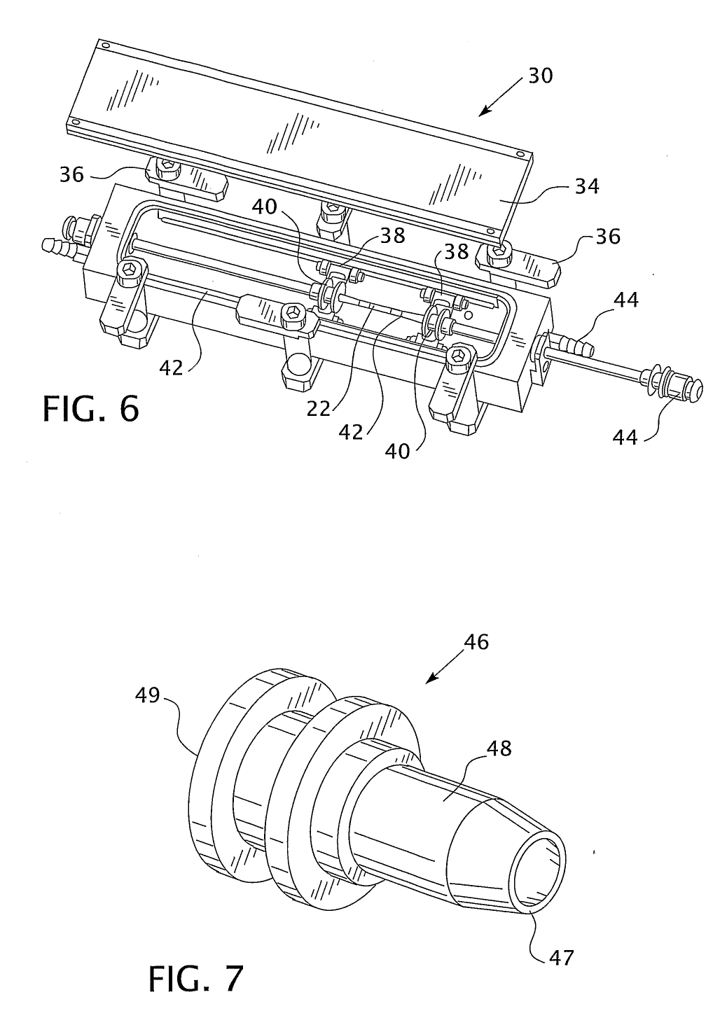

In an embodiment of the present invention, as shown in FIGS. 5-6, the blood vessel bioreactor 30 is depicted which has a flow system comprised of adjustable, rigid tubing 42 at each end of the bioreactor 30. Each tubing 42 can be affixed at its terminal end to one end of a blood vessel inlet/outlet cuff connector 40. The other end of the blood vessel inlet/outlet cuff connector 40 can be affixed to an end of either a native blood vessel segment 22 detached from the body of an animal or human or to a tissue-engineered biosynthetic construct. A carrier structure 38 is configured to affix atop the blood vessel inlet/outlet cuff connector 40 in order to secure the blood vessel inlet/outlet cuff connector 40 to both the blood vessel segment end 22 and to the vacuum tubing 42.

The interior of the tubing 42 contains a nutritive fluid flow to provide nutritive fluid through the blood vessel inlet/outlet connector cuff 40 to the interior of the blood vessel segment 22. Additionally, the blood vessel bioreactor 30 has a plurality of knobs 44 located on the external surface of the bioreactor 30 which connect to the tubing 42 to adjust the length of the tubing 42 in conformance with the length of the blood vessel segment 22.

Each end of the blood vessel inlet/outlet connector cuff 30 also is configured to connect to adjustable, rigid tubing 42 having a nutritive fluid flow therein to provide nutritive fluid to the exterior of the blood vessel segment 22.

The bioreactor 30 optionally has a transparent cover 34 and locking clamps 36 for sealing the transparent cover 34 onto the bioreactor 30.

As shown in FIGS. 7-14, the blood vessel inlet/outlet cuff connectors of the present invention can have a multiplicity of designs, which include, for example and without limitation, bayonet-type tapered connectors, mechanical clamp connectors, vacuum-operated blood vessel connectors or perforated magnetic sleeve blood vessel connectors.

FIG. 7 shows a bayonet-type tapered connector 46 comprised of a tube 48 which can have varying outer and inner diameter bore sizes. The distal end 47 of the bayonet-type tapered connector 46 is configured to affix to a severed blood vessel segment (not shown) and a proximal end 49 is configured to affix to a nutritive flow system of a flow chamber (not shown).

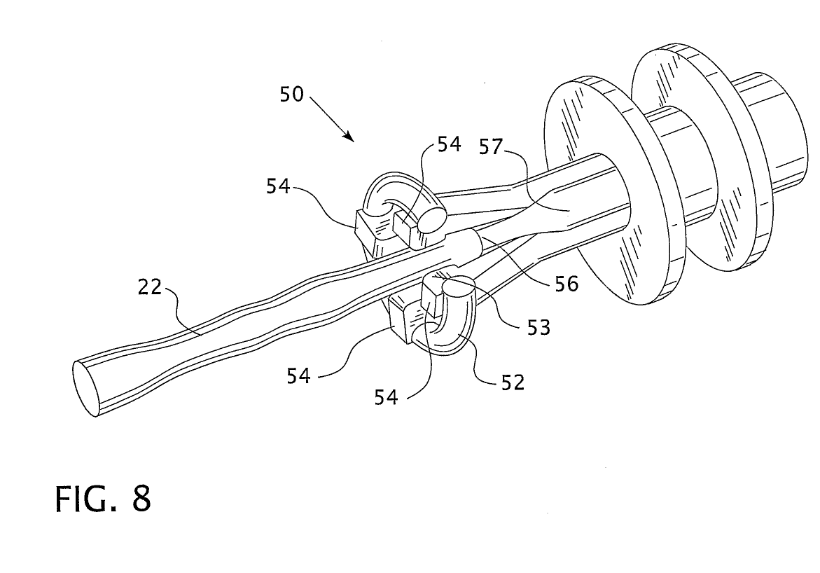

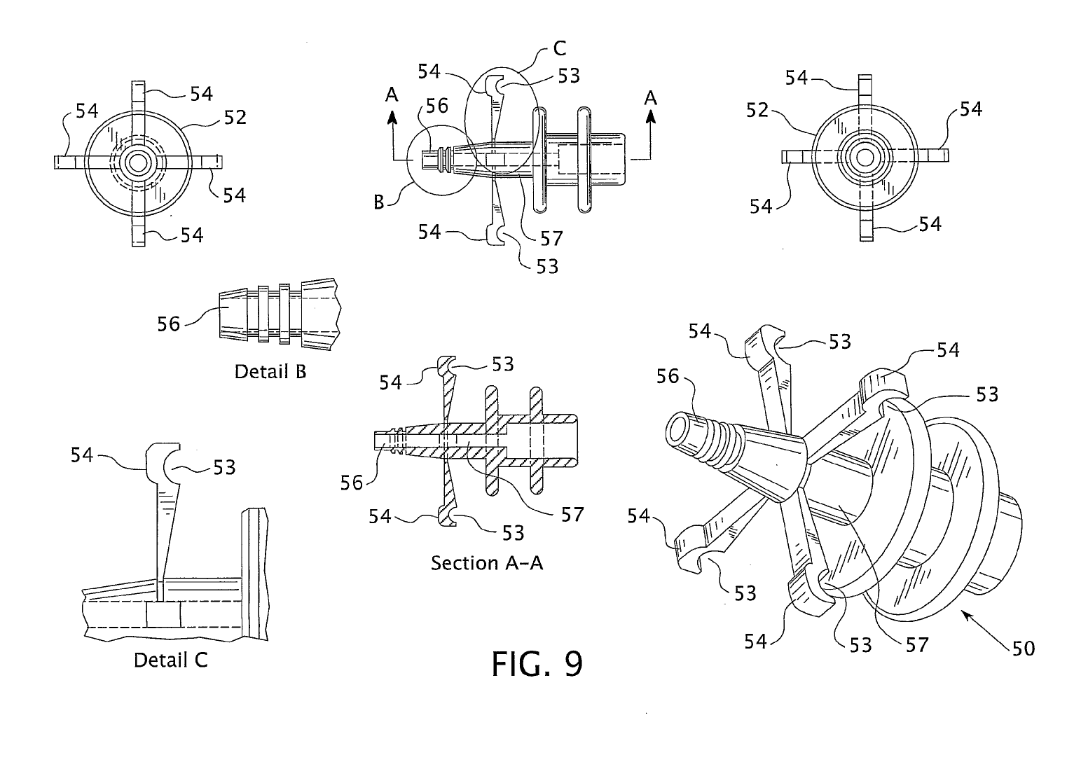

FIGS. 8-9 show a mechanical clamp connector 50 comprised of a tube 57 that terminates into a bayonet-type fitting 56. The tube 57 has a clamp engagement mechanism comprised of at least four flexible hinge arms 54. Each arm 54 has a depression 53 in the distal portion of the arm 54 to receive a flexible “O” ring 52 therein. The arms 54 are configured to engage the outer wall end of the blood vessel segment 22 mounted onto the bayonet-type fitting 56. The arms 54 are engaged onto the exterior of the blood vessel segment 22 by means of an “O” ring engagement clamp 52.

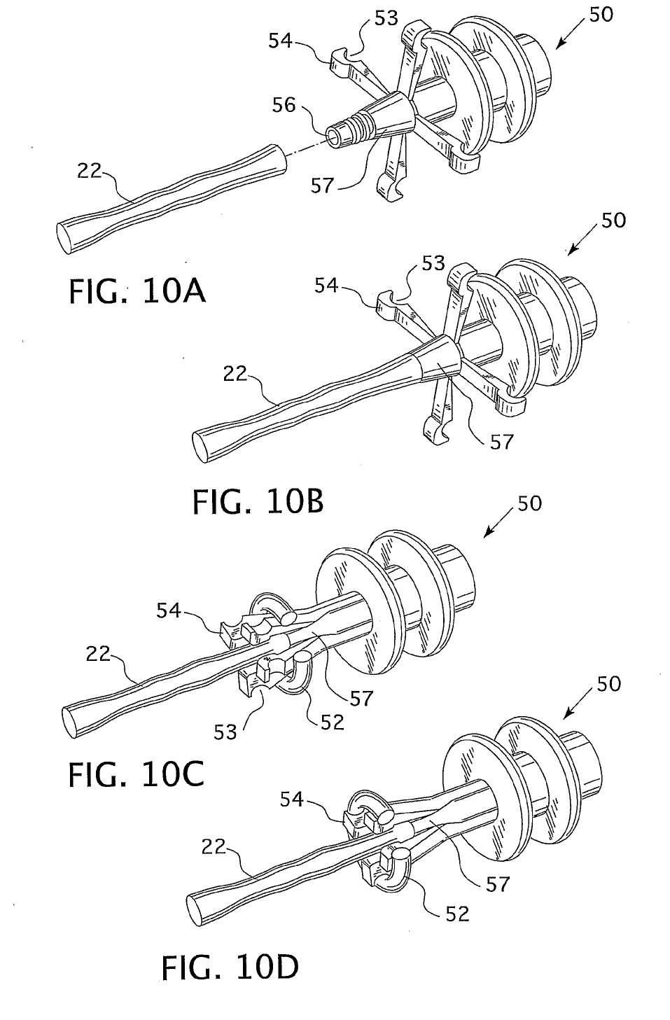

FIG. 10A shows the mechanical clamp connector 50 in which the arms 54 are extended to receive the blood vessel segment 22. FIG. 10B shows the blood vessel segment 22 affixed around the bayonet-type fitting 56 at the distal end of the tube 57. In FIG. 10C, the arms 54 are positioned more circumferentially with respect to the bayonet-type fitting 56 and blood vessel segment 22 affixed thereon to apply pressure thereto by virtue of the flexible “O” ring 52 which is received into the depression 53 in each distal portion of each arm 54. In this way, the end of the blood vessel segment 22 is captured and immobilized on the mechanical clamp connector 50. FIG. 10D shows the clamped end of the blood vessel segment 22 captured by the mechanical clamp connector 50.

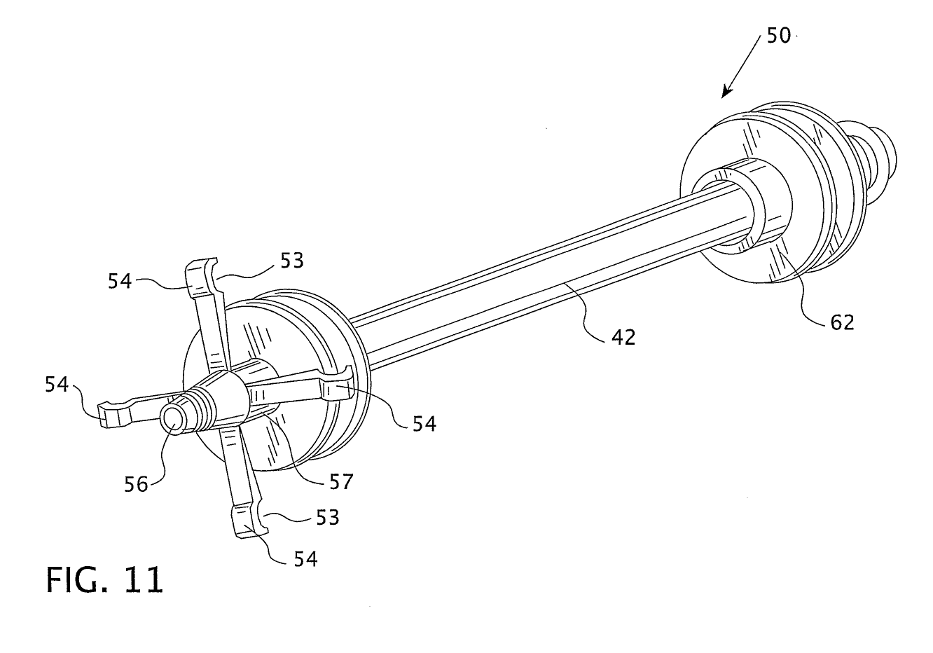

FIG. 11 shows the mechanical clamp connector 50 in which adjustable, rigid tubing 42 is affixed to the distal end of the mechanical clamp connector 50 and a seal and flow connector 62 is affixed to the proximal end of the mechanical clamp connector 50.

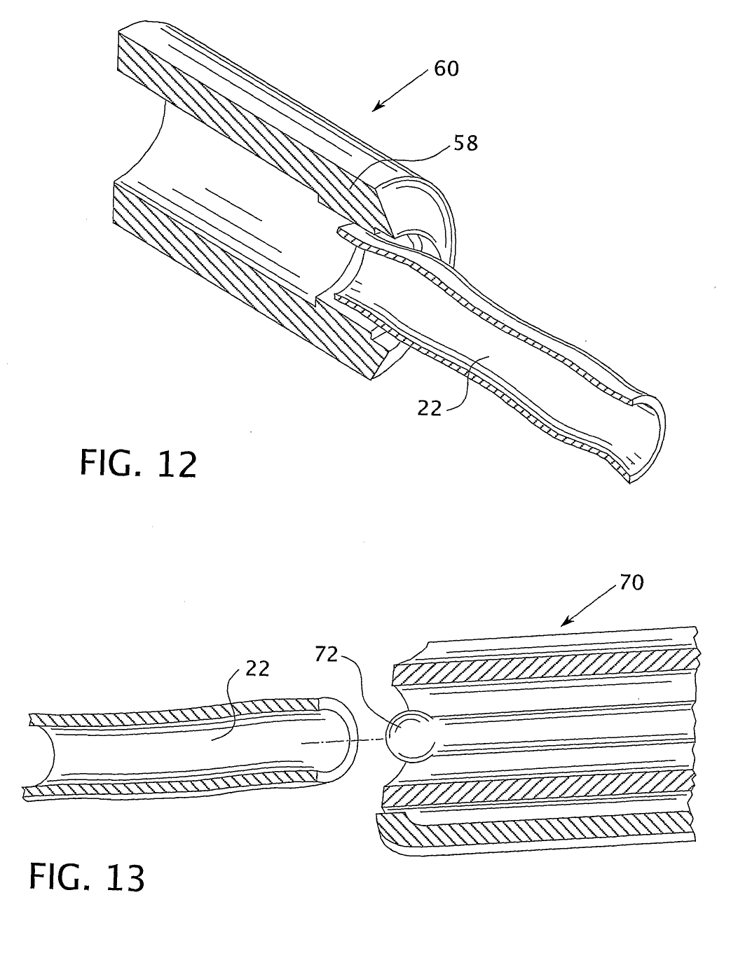

FIG. 12 shows a wet tack sleeve blood vessel connector 60 in which a wet tack sleeve 58 is configured to slide over the exterior of a blood vessel segment 22. The wet tack sleeve 58 is fabricated to shrink in dimension, and thus provides circumferential pressure that clamps the blood vessel segment 22 to the distal end of the wet tack sleeve connector 60.

FIG. 13 shows a vacuum-operated blood vessel connector 70 which engages the end of the blood vessel segment 22 and draws it into a barbed three-dimensional annular material 72 which prevents pull-out or leaking of the blood vessel segment 22. In this way, a positive seal to the inlet and outlet of the blood vessel is ensured.

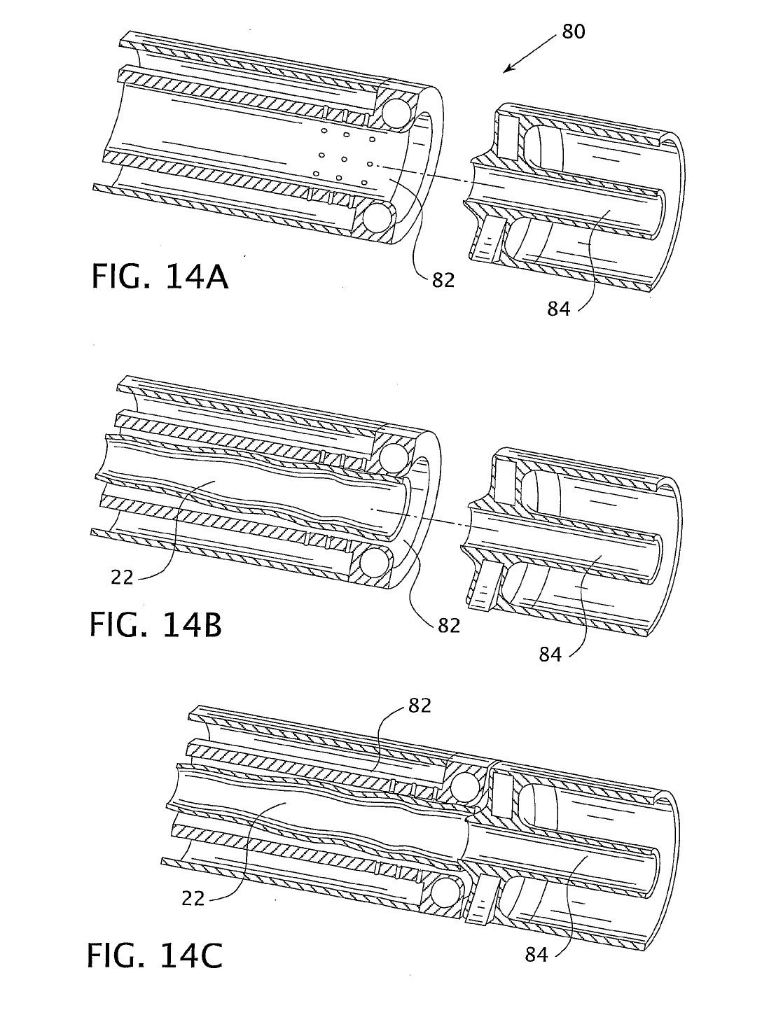

FIGS. 14A-C show a two-piece perforated magnetic sleeve blood vessel connector 80 having a perforated magnetic sleeve 82 for use in a vacuum-operated and magnetic blood vessel attachment connector. FIG. 14A shows the two parts of the perforated magnetic sleeve. FIG. 14B shows the perforated magnetic sleeve with a blood vessel therein. FIG. 14C shows the engagement of the two parts of the perforated magnetic sleeve. The perforated magnetic sleeve 82 engages with a continuous flange 84 which couples the exterior of a blood vessel segment wall with a like fixture on the inlet or outlet end of the nutritive flow system.

In an embodiment of the present invention, the blood vessel bioreactor system is equipped with sensors capable of providing a read-out of O₂ and CO₂ content, pH, pressure and bacterial contamination (assessed by, for example and without limitation, turbidity or conductivity of the fluid medium) in the internal fluid medium as well as in the external fluid medium. Additionally, the computer-operated flow control system is able to regulate the flow within the lumen of the tubings, blood vessel inlet and outlet cuff connectors and blood vessel segment with respect to duration, flow rate and directionality so as to provide a regulated steady flow, an oscillating flow, or flow reversals, as provided in the commercially available STREAMER™ flow device manufactured by Flexcell International Corp. Additionally, the blood vessel bioreactor system of the present invention is configured to apply regulated, uniaxial tension to the blood vessel segment by means of one or both ends of the blood vessel inlet and outlet cuff connectors which translate axially according to a computer-generated programmable regimen.

In another embodiment of the present invention, the bioreactor system can be set up as a series of bioreactors which are engaged on a linear or circular frame with separate or shared nutritive fluid flow systems.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

The invention claimed is:

1. A blood vessel bioreactor system for the harvesting, transport, maintenance and development of native or biosynthetic blood vessels, comprising a blood vessel harvest and carriage cassette and a computer-operated blood vessel bioreactor flow system.

2. The blood vessel bioreactor system according to claim 1, wherein the blood vessel harvest and carriage cassette is comprised of a blood vessel transport cassette having a linear, tubular handle positioned centrally thereon, said linear, tubular handle being in line with vacuum tubing extending out from either side of the handle, wherein the interior of the handle communicates with a vacuum connection within the vacuum tubing, wherein each end of the vacuum tubing terminates in a blood vessel end engagement part having a blood vessel attachment/engagement cuff thereon.

3. The blood vessel bioreactor system according to claim 1, wherein the transport cassette has a depression therein for filling with a nutritive fluid.

4. The blood vessel bioreactor system according to claim 2, wherein the blood vessel attachment/engagement cuff is perforated and circular.

5. The blood vessel bioreactor system according to claim 2, wherein the blood vessel attachment/engagement cuff is perforated and semicircular.

6. The blood vessel bioreactor system according to claim 2, wherein rotation of the handle varies the length of the vacuum tubing.

7. The blood vessel bioreactor system according to claim 2, wherein the blood vessel attachment/engagement cuff is designed to attach via vacuum aspiration to the exterior wall of a blood vessel of an animal or human, said attachment proximal to the segment end of the blood vessel in order to immobilize and maintain the blood vessel segment in a patent state.

8. The blood vessel bioreactor system according to claim 7, wherein the attached blood vessel segment is detached from the remainder of the blood vessel that remains intact in the body of the animal or human.

9. The blood vessel bioreactor system according to claim 8, wherein the detached blood vessel segment is transported in the transport cassette.

10. The blood vessel bioreactor system according to claim 9, wherein the handle removes the transported detached blood vessel segment from the transport cassette to a flow chamber in the bioreactor, said flow chamber having blood vessel inlet/outlet cuff connectors.

11. The blood vessel bioreactor system according to claim 10, wherein the bioreactor is comprised of a bioreactor body having a flow system comprised of adjustable, rigid tubing at each end of the bioreactor, wherein each end of tubing affixes to one end of a blood vessel inlet/outlet cuff connector, and wherein the other end of the blood vessel inlet/outlet cuff connector affixes to an end of a blood vessel segment.

12. The blood vessel bioreactor system according to claim 11, wherein the blood vessel segment is a native blood vessel segment from the body of an animal or human or a tissue-engineered biosynthetic construct.

13. The blood vessel bioreactor system according to claim 12, wherein the interior of the tubing contains a nutritive fluid flow to provide nutritive fluid through the blood vessel inlet/outlet connector cuff to the interior of the blood vessel segment.

14. The blood vessel bioreactor system according to claim 10, wherein each end of the blood vessel inlet/outlet connector cuff is connected to adjustable, rigid tubing having a nutritive fluid flow therein to provide nutritive fluid to the exterior of a blood vessel segment.

15. The blood vessel bioreactor system according to claim 11, wherein a plurality of knobs located externally to the bioreactor and connected to the tubing adjusts the length of the tubing to conform to the length of the blood vessel segment.

16. The blood vessel bioreactor system according to claim 1, wherein the bioreactor has a transparent cover and locking clamps, said locking clamps capable of sealing the transparent cover onto the bioreactor.

17. The blood vessel bioreactor system according to claim 11, wherein a carrier is affixed atop the blood vessel inlet/outlet cuff connector to secure the blood vessel inlet/outlet cuff connector to both the blood vessel segment end and to the vacuum tubing.

18. The blood vessel bioreactor system according to claim 10, wherein the blood vessel inlet/outlet cuff connectors are selected from the group consisting of bayonet-type tapered connectors, mechanical clamp connectors, vacuum-operated blood vessel connectors and perforated magnetic sleeve blood vessel connectors.

19. The blood vessel bioreactor system according to claim 10, wherein the blood vessel inlet/outlet cuff connector is a mechanical clamp connector.

20. The blood vessel bioreactor system according to claim 19, wherein the mechanical clamp connector is comprised of a tube that terminates as a bayonet-type fitting that affixes to the end of a blood vessel segment, said tube having a clamp engagement mechanism comprised of at least four flexible hinge arms, wherein each hinge arm has a depression in the distal portion of the arm to receive a flexible “O” ring therein, and wherein the arms engaged the outer wall of the blood vessel segment mounted onto the bayonet-type fitting when the “O” ring clamps into the depression in each arm.

21. The blood vessel bioreactor system according to claim 1, further comprising sensors capable of providing read-outs of O₂ and CO₂ content, pH, pressure and bacterial contamination.

22. The blood vessel bioreactor system according to claim 1, wherein the computer-operated flow system of the bioreactor regulates the fluid flow within the lumen of the tubings, blood vessel inlet/outlet cuff connectors and blood vessel segment with respect to duration, flow rate and directionality.

23. The blood vessel bioreactor system according to claim 22, wherein the regulated fluid flow is a steady flow, oscillating flow or reversal of flow.

24. The blood vessel bioreactor system according to claim 11, wherein the bioreactor is able to apply regulated, uniaxial tension to a blood vessel segment by means of one or both blood vessel inlet/outlet cuff connectors pulling axially on the blood vessel segment according to a computer-generated programmable regimen.

25. The blood vessel bioreactor system according to claim 1, wherein a series of bioreactors are engaged on a linear or circular frame with separate or shared nutritive flow systems.
